(19) United States
(12) Patent Application Publication
(10) Pub. No.: US 2015/0305516 A1
(43) Pub. Date: Oct. 29, 2015

(54) OUTDOOR SEAT SYSTEM HAVING A PROTECTIVE CASE AGAINST THE WEATHER OR THE ELEMENTS

(71) Applicant: Maurice James Lacy, Healesville (AU)

(72) Inventor: Maurice James Lacy, Healesville (AU)

(21) Appl. No.: 14/263,923

(22) Filed: Apr. 28, 2014

(51) Int. Cl. A47C 31/00; G07C 9/00; A47C 17/04; A47C 7/54; A47C 7/40

(52) U.S. Cl. CPC A47C 31/004; A47C 7/54; A47C 7/407; A47C 17/04; G07C 9/00007

(57) ABSTRACT

The invention provides a couch or sofa system that comprises a self-contained seat within a protective case or box. The protective case or box may be opened to reveal a swiveling-up couch or sofa. The protective case or box seals the couch or sofa from the elements and may thus be used in almost any environment, hostile or otherwise, having the further benefit of preventing degradation of the couch or sofa over the years.

This application is a non-provisional application claiming priority to U.S. Provisional Patent Application Ser. No. 61/816,845 entitled “Outdoor Couch or Sofa Having a Protective Case Against the Weather or the Elements”, filed Apr. 28, 2013, which is herein incorporated by reference in its entirety for all purposes.

### BACKGROUND

Couches, sofas, folding sofas, and retractable sofas are well known in the art, and are generally considered as sofa-bed combinations. However, there are none that are adapted being a single unit or system that allows the owner or user to leave the furniture exposed to the elements without having to obtain additional coverings. Those coverings frequently comprise low-quality plastic compositions that are susceptible to extreme temperature and light exposure fluctuations and degrade rapidly upon exposure over time.

Moreover none of such folding or retractable sofas are utilized at open air recreational, lifestyle, sporting, entertainment or hotel venues so as to offer users the ability to sit in comfort with access to electronic facilities which proffer food drink and other services from a remote service catering facility.

For example, US Pat. Appl. No. 20050140197 (Lee, S.), a “Furniture Piece”, disclosing a chair in exemplary form having the shape of a sperm whale, having a hinged backrest and a hinged seat attached to a base. In use, the backrest is in the uptight position and the seat is horizontal. To convert to the storage mode, the backrest can be pivoted forwards to rest upon the horizontal seat. In the alternative, the hinged seat may be pivoted upwards, the backrest pivoted forwards to lay flat upon the base and the seat is then re-pivoted back to lay in a near-horizontal position resting upon the rear of the backrest. No covering case is disclosed. There is no disclosure relating to using or leaving the seat outside exposed to the elements. The “whale” sofa is not designed to fold onto itself and to comprise a box-storage unit.

In another example of the prior art, U.S. Pat. No. 4,865,387 (to Lipparini et al.), the disclosure is drawn to an articulated support rod for forward folding backs of seats such as sofa, armchair, or the like. The disclosure appears to be limited to a rod formed by a row of arms connected in an end-to-end relation by means of a frictional articulation, and comprises means for the connection to the main frame of the seat and, at the free end, a flat elongated plate. No covering case is disclosed.

A third example of the prior art, GB 792,949A to Wheeler, 1956, discloses a folding cabinet bed (FIG. 1 and FIG. 2 of Wheeler) convertible into a sofa which has a cabinet with a front wall closure on hinges and carrying a bed unit supporting a mattress spaced from the inner wall of the closure, upper and lower storage compartments within the cabinet and counterbalancing means for the bed unit disposed between the mattress and closure. A bin extending substantially the length of the mattress receives for storage sofa cushions and above the bin, secured to the top wall of the cabinet by rollers moving in tracks is a multiple unit providing compartments with doors to receive pillows and bedding the unit being normally held inwardly by light spring but rolled forwardly and supported there by chains joining ends of a pivoted back-rest by means of which the bed is converted to a sofa. A central compartment may be an open shelf to receive a radio or clock and end compartments house disappearing lamps mounted on pivoted panels. The counterbalancing means embodies a heavy coil-spring secured to each end wall of bed unit by a bracket and at its other end to a cable passing around a pulley bracket on bed unit rear wall and through a transverse groove to be coupled with the other spring. The end of the spring secured to cable is also secured to leg operating cables passing around pulley brackets and having their ends secured to legs pivotally mounted between front wall and a bracket so that as the bed unit is lowered and spring is stretched to counterbalance the weight of the unit the cables are moved to lower the legs, an intermediate tension spring assisting the return of the legs when the bed is moved to the storage position. Wheeler does not contemplate using the folding cabinet bed in an outdoor setting and does not contemplate that the cabinet bed might protect the bed from environmental exposure.

### SUMMARY OF THE INVENTION

The present invention relates to a couch system having a collapsible frame which folds or retracts into a protective case. The couch system has advantages in that it protects the seating portions from exposure to the elements.

The invention contemplates a couch comprising a frame, the frame comprising a base, two armrests, and a front. The couch further comprises a mechanism that is shaped and adapted to be set into or upon the frame, wherein the mechanism further comprises a seat and a backrest. The mechanism is further adapted to enable a user to move the backrest relative to the seat, and further, to enable the user to move the backrest so that it lies substantially horizontally upon the upper surface of the seat. The seat further comprises cushioning material and fabric material that covers the seat to ensure a comfortable support for the user thereby creating a cushioned seat. The armrests may also comprise similar cushioning material and fabric material. The backrest may also comprise similar cushioning material and fabric material.

In one embodiment, the base is shaped and adapted to form a substantially rectangular open box. The base comprises a resilient material that is resistant to damage including ultra violet radiation damage under a wide range of temperatures, such as, but not limited to a range of −20° C. to 140° C. In another embodiment the base comprises a resilient material that is resistant to damage under a wide range of humidity, such as, but not limited to a range of 10% to 90% relative humidity. In another embodiment the base comprises a resilient material that is resistant to damage by prolonged exposure to rainwater, such as a hurricane or typhoon lasting for several hours or such as a 30 cm flood over a period of one week.

The couch further comprises a lid, the lid forming a substantial part of the backrest and wherein the lid comprises an inner surface and an outer surface. The inner surface of the lid comprises cushioning material and fabric material that covers the inner surface of the lid to ensure a comfortable support for the user thereby creating a cushioned backrest and which comprises a substantial portion of the backrest. The outer surface of the lid is shaped and adapted to form a substantially rectangular open box. The lid comprises a resilient material that is resistant to damage, including ultra violet radiation damage, under a wide range of temperatures, such as but not limited to a range of −20° C. to 140° C. In another embodiment the lid comprises a resilient material that is resistant to damage under a wide range of humidity, such as, but not limited to a range of 10% to 90% relative humidity. In another embodiment the lid comprises a resilient material that is resistant to damage by prolonged exposure to rainwater, such as a hurricane or typhoon lasting for several hours or such as a 30 cm flood over a period of one week.

In yet another embodiment the invention contemplates a chair having options that comprise an indentation on the upper surface of the lid, the indentation being in the form of a bucket or chair seat. A user may use the invention in the locked and closed configuration and sit on the conventional indentation on the lid if he or she elects not to choose to utilize the facilities proffered internally such as are described above.

### BRIEF DESCRIPTION OF THE DRAWINGS

FIG. 1 illustrates the couch system in a closed (A) and (B) and open (C) and (D) configuration in a side (A) and (C) or a front (B) and (D) perspective.

FIG. 2 illustrates the couch system in a partially closed and folding configuration in a side (A) or a front (B) perspective.

FIG. 3 illustrates the couch system in a closed configuration showing more details of the arrangement of the seat, backrest, lid, and base.

FIG. 4 illustrates an exploded view of the components of the structure that is within the confines of the couch system and which enables the seat and backrest to be opened and closed.

FIG. 5 illustrates an alternative exemplary embodiment of the couch system showing the couch closed (A) and open (B).

FIG. 6 illustrates a side view of the couch system open showing the detailed arrangement of the structural components that comprise the open/close mechanism and also shows exemplary dimensions in centimeters.

FIG. 7 illustrates a side view of the couch system closed showing the detailed arrangement of the structural components that comprise the open/close mechanism and also shows exemplary dimensions in centimeters.

FIG. 8 illustrates an exploded view of an alternative example of the structural components of the open/close mechanism.

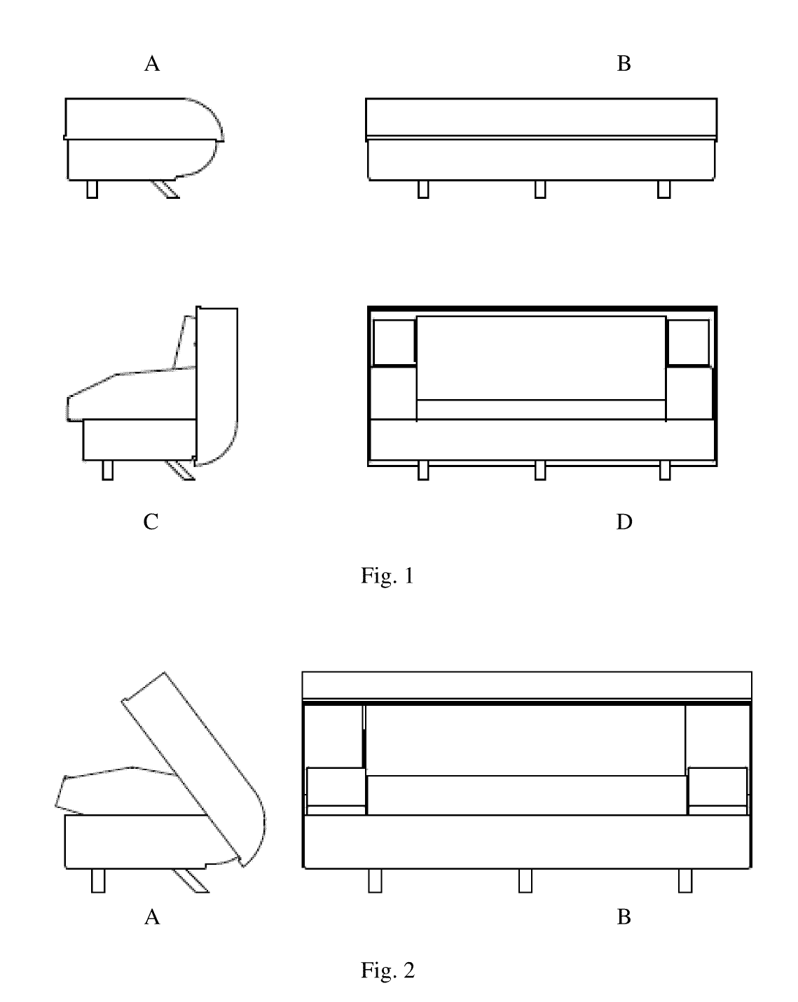

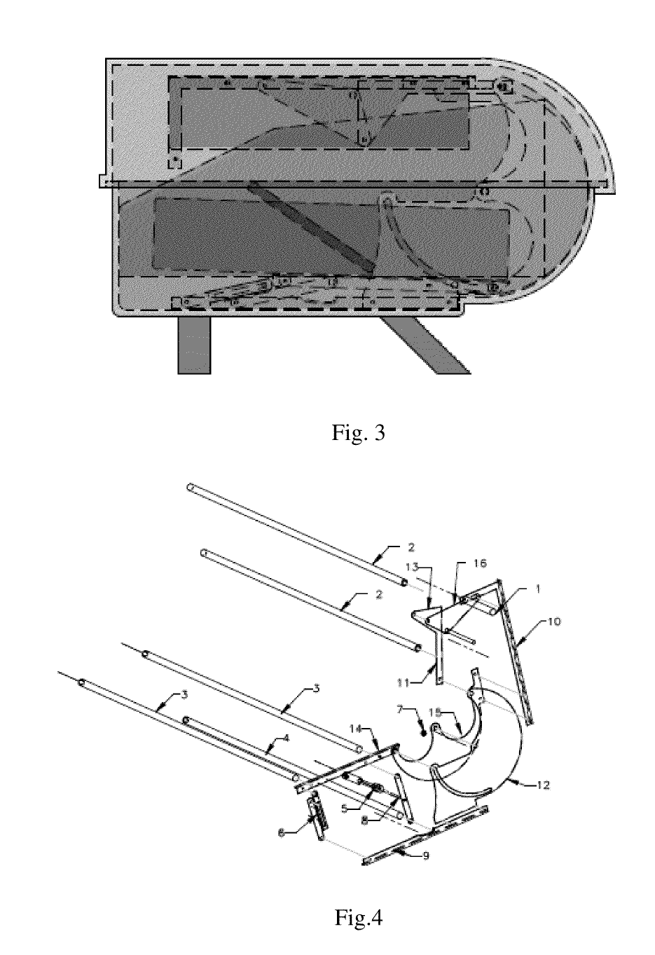

### DETAILED DESCRIPTION OF THE INVENTION

The couch system herein disclosed can be used in many different environments, including deserts, forests, plains, steppes, savannas, mountains, tundra, farmland, and habitation gardens or backyards. The couch system can also be referred to as a chair, a couch, a sofa, a foldaway, a chaise-longue, a chaise-marine, an arm-chair, a settee, a settle, and a seat.

The mechanism is shaped and adapted so that in use, a user applies gentle pressure in a horizontal direction to the backrest and which results the backrest to swing in the direction of movement and wherein the inferior portion of the backrest is adaptively pivoted with the base. The superior portion of the backrest then arcs down towards the upper surface of the cushioned seat. At the same time, the lid contacts the base thereby creating a closed box. In one preferred embodiment, latches, locks, buckles, each or together may be attached to the outer surface of the lid and the base so that they may be used to secure the closed box. In a further preferred embodiment an electronic lock is placed on the outside casing of the unit wherein by insertion or swiping of a credit card or key (for instance, a hotel pass card or hotel key) by the user the unit is opened thus providing access to the interior couch and electronic media and other facilities contained therein.

In another embodiment the invention can be used having the following configuration and method of use. As the box is closed, by upward pressure being placed by a user on the bottom front rim, the seat, which protrudes out of the front of the container in open position, rises upward as the rear of the seat drops downward and draws into the bottom rear of the container. As it draws in, the front edge of the seat rises over the front edge of the container (box) and then drops down resting flat in the base of the container taking up the internal horizontal depth of its storage area. Similarly the seat back (back rest) retracts into top of the container with the face of the seat back resting flat on the top of the retracted lower seat. The back of the seat slides neatly between the two side arms that lowers and rest between the bottom and top of the container shell.

On advantage of the couch system is that it resists damage when exposed to environmental insult, such as extreme heat and cold, extreme dry or wet, and extremes of atmospheric pressure. Thus, it may be used in almost all terrestrial environments and in particular, could be left outside during the winter or cold or rainy season(s) by the owner without concern that the couch system might be damaged or weathered during that time. It therefore would be of use to outdoor commercial enterprises where clients and/or customers and/or guests tend to visit during warm or dry seasons, thus providing the enterprise savings of covering or retrieving or storing the couch system during seasons of extreme environmental change.

In another example, the system may have the conventional “chair seat indentation” on top with aperture for a smart card or credit card somewhere in place—the user can insert or swipe the card if he or she wants to use the special features. When this happens the chair opens into a type of airline feature providing services such as, on-line ordering of drinks and food, AC or DC heating facility, charging facilities for phones and computers, and further comprising fold-out eating trays, and fold-out television facilities. This has advantages for use in major public venues such as the tennis, baseball, swimming, and football, or in hotel poolside areas, etc. In such a manner, the user has the choice of cheap entertainment by sitting on a conventional chair or opening up the opportunity to have something special that he or she can utilise at any time during the entertainment/game or poolside activity. Moreover if the user elects to utilize these “in chair” services he or she shall be able to pay for such services by remote debit or credit card transactions. One other benefit will be that the venue offering the service will be able to take orders for food, drink, etc., without staff needing to personally take orders from patrons sitting at the venue thus providing labor cost savings to such establishments.

Another advantage that the instant invention can be considered to have over the prior art is that it has been conceived as solving the problem of having a comfortable piece of furniture available in a single unit available for use at all times of the year and which is protected from the elements and having the capacity to be utilized in some venues or locations where it is positioned to order and purchase services, food and drink from a remote source. One of ordinary skill in the art would not consider using the cabinet-sofa combination of Wheeler as outdoor furniture. In addition, unlike Wheeler, the instant invention provides a bench when the lid is closed, one of skill in the art would not consider or be motivated to turn the cabinet-sofa as described in Wheeler upon its back.

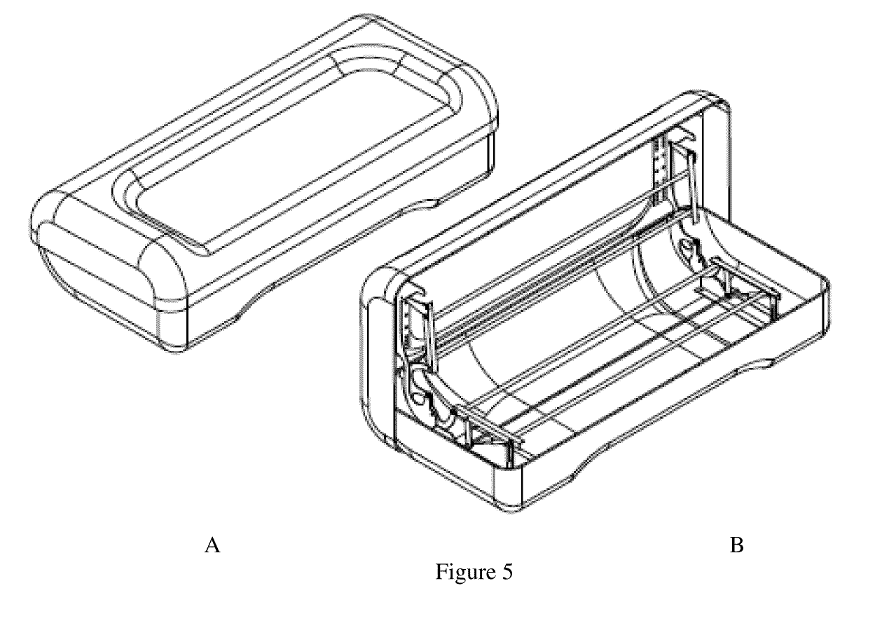

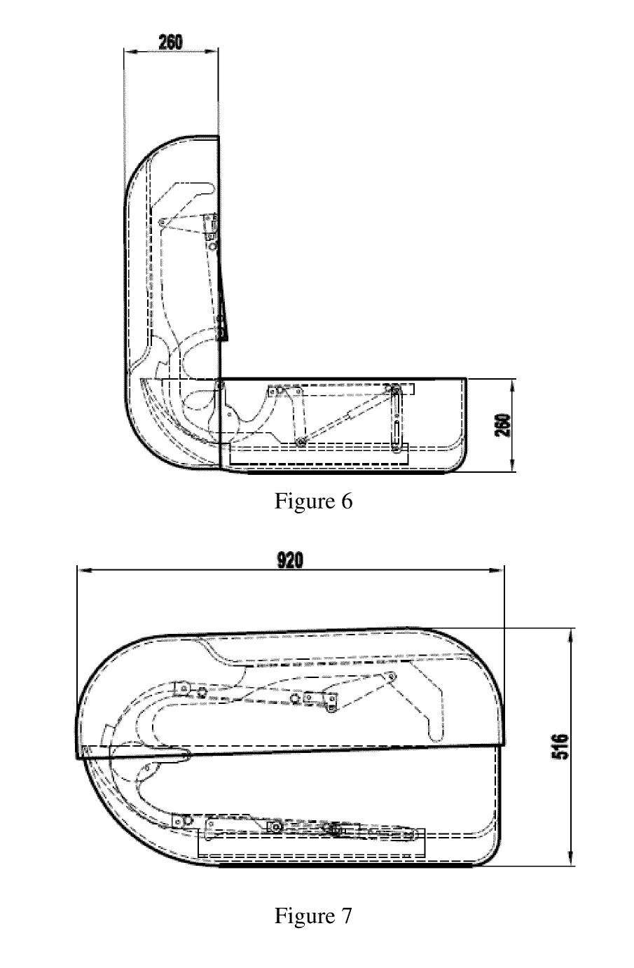

FIG. 4 illustrates an exploded view of exemplary structural components of the couch system mechanism within the confines of the couch system and which enables the seat and backrest to be opened and closed. The exemplary components are:
1. Swivel Panel Mount and Guide
2. Back Seat Support Rails
3. Bottom Seat Support Rails
4. Leg Support Rod
5. Gas Strut
6. Sliding Telescopic Front Leg Mechanism
7. Mechanical Bush
8. Gas Strut Mount Support
9. Bottom Rail Fixed to Containing Box and Seat Hinge
10. Mounting Rail for Lid and Hinging Mechanism
11. Back Support Strut
12. Slotted Main Support Bracket
13. Swivel Bracket with Guide Rod
14. Seat Support Bracket
15. Pivot Bracket
16. Back Support Bracket

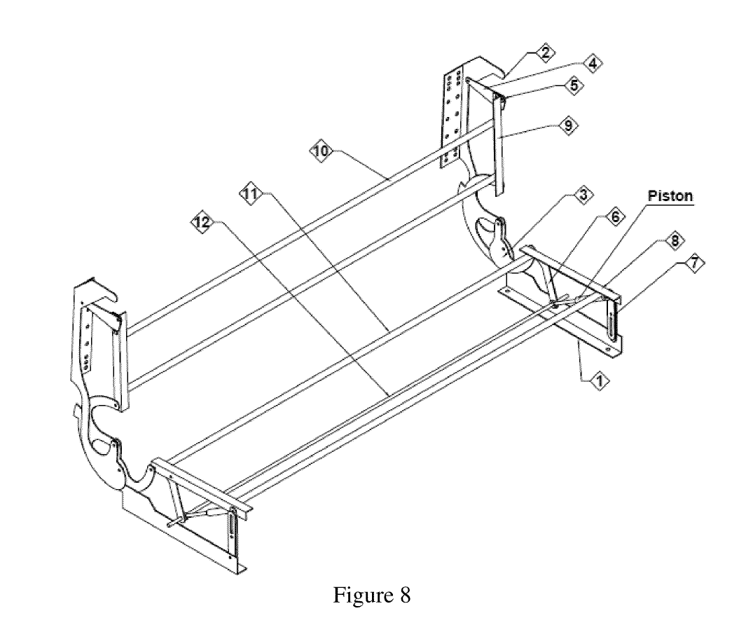

FIG. 8 illustrates an exploded view of alternative exemplary structural components of the couch system mechanism within the confines of the couch system and which enables the seat and backrest to be opened and closed. The exemplary components are:
1. Bottom Rail Fixed to Containing Box and Seat Hinge
2. Mounting Rail for Lid and Hinging Mechanism
3. Pivot Bracket
4. Back Support Bracket
5. Swivel Bracket with Guide Rod
6. Piston Mount Support
7. Sliding Telescopic Front Leg Mechanism
8. Seat Support Bracket
9. Back Support Strut
10. Back Seat Support Rails
11. Bottom Seat Support Rails
12. Leg Support Rod
Also shown: Piston

Another advantage of the couch system is that the base and lid comprise a resilient material that is resistant to damage including ultra violet radiation damage under a wide range of temperatures, ambient or otherwise, such as, but not limited to a range of −20° C. to 140° C. For example the temperature may be −20° C., −15° C., −10° C., −5° C., 0° C., 5° C., 10° C., 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., or thereabout.

Yet another advantage of the couch system is that the base and lid comprise a resilient material that is resistant to damage under a wide range of humidity, such as, but not limited to a range of 10% to 90% relative humidity. For example the humidity may be 10%, 15%, 20%, 25%, 30%, 35%, 40%, 45%, 50%, 55%, 60%, 65%, 70%, 75%, 80%, 85%, 90%, or thereabout.

One additional advantage of the couch system and mechanism disclosed herein is that there are few moving parts and consequently, there is a lower likelihood that the parts or components will undergo structural damage or failure due to use or to environmental stress, such as rusting or other oxidation reactions. In one embodiment, the system does not comprise any springs or the like. In another embodiment, springs or the like may be used in the mechanism.

Those skilled in the art will appreciate that various adaptations and modifications of the just-described embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention can be practiced other than as specifically described herein. The above description is intended to be illustrative, and not restrictive. Many other embodiments will be apparent to those of skill in the art upon reviewing the above description. The scope of the invention should, therefore, be determined with reference to any appended claims, along with the full scope of equivalents to which such claims are entitled.

I claim:

1. A couch comprising a frame, the frame comprising a base, two armrests, and a front, the couch further comprises a mechanism that is shaped and adapted to be set into or upon the frame, wherein the mechanism further comprises a seat and a backrest.

2. The couch of claim 1, wherein the mechanism is further adapted to enable a user to move the backrest relative to the seat, and further, to enable the user to move the backrest so that it lies substantially horizontally upon the upper surface of the seat.

3. The couch of claim 1, wherein the seat further comprises cushioning material and fabric material that covers the seat to ensure a comfortable support for the user thereby creating a cushioned seat.

4. The couch of claim 1, wherein the armrests comprise said cushioning material and said fabric material.

5. The couch of claim 1, wherein the backrest comprises said cushioning material and said fabric material.

6. The couch of claim 1, wherein the base is shaped and adapted to form a substantially rectangular open box and wherein the base comprises a resilient material that is resistant to damage.

7. The couch of claim 1, wherein the couch further comprises a lid, the lid forming a substantial part of the backrest and wherein the lid comprises an inner surface and an outer surface.

8. The couch of claim 7, wherein the inner surface of the lid comprises cushioning material and fabric material that covers the inner surface of the lid to ensure a comfortable support for the user thereby creating a cushioned backrest and which comprises a substantial portion of the backrest.

9. The couch of claim 7, wherein the outer surface of the lid is shaped and adapted to form a substantially rectangular open box.

10. The couch of claim 7, wherein the lid and/or the base comprise a resilient material that is resistant to damage.

11. The couch of claim 10, wherein the damage is selected from the group consisting of ultra violet radiation damage and a wide range of temperature damage.

12. The couch of claim 11, wherein the wide range of temperature damage is between a range of −20° C. to 140° C.

13. The couch of claim 7, wherein the lid comprises a resilient material that is resistant to damage under a wide range of humidity.

14. The couch of claim 13, wherein the wide range of humidity is between a range of 10% to 90% relative humidity.

15. The couch of claim 7, wherein the lid and/or the base comprise a resilient material that is resistant to damage by prolonged exposure to rainwater.

16. The couch of claim 15, wherein the prolonged exposure to rainwater is selected from the group consisting of a hurricane or typhoon lasting for several hours and a 30 cm flood over a period of one week.

17. The couch of claim 1, wherein the backrest comprises an inferior portion and a superior portion, and wherein the mechanism is shaped and adapted so that in use, a user applies gentle pressure in a horizontal direction to the backrest and which results the backrest to swing in the direction of movement and wherein the inferior portion of the backrest is adaptively pivoted with the base; the superior portion of the backrest then arcs down towards the upper surface of the cushioned seat; at the same time, the lid contacts the base thereby creating a closed box.

18. The couch of claim 17, where the lid and base further comprise latches, locks, buckles, each or together attached to the outer surface of the lid and the base so that they may be used to secure the closed box.

19. The couch of claim 17, wherein the lid or the base comprise an electronic lock and wherein by insertion or swiping of a card or key through the electronic lock the unit is unlocked, thus providing access to the couch.

20. The couch of claim 19, wherein the card or key is selected from the group consisting of a credit card, a hotel pass card, a key and a hotel key.
